(19) United States
(12) Patent Application Publication
(10) Pub. No.: US 2006/0049953 A1
(43) Pub. Date: Mar. 9, 2006

(54) Container having photo-audio effect

(76) Inventor: Chin-Lai Su, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/934,127

(22) Filed: Sep. 7, 2004

(51) Int. Cl. G08B 21/00

(52) U.S. Cl. 340/618

(57) ABSTRACT

A container includes a photo-audio drive circuit including a photo-audio IC (integrated circuit), at least one light emitting member connected to the photo-audio IC, a loudspeaker connected to the photo-audio IC, and two exposed connecting legs each connected to the photo-audio IC. Thus, the two exposed connecting legs are electrically connected with each other when contacting liquid to conduct the photo-audio drive circuit to form a circuit, so that the photo-audio IC drives the light emitting member to light and drives the loudspeaker to emit sound.

### BACKGROUND OF THE INVENTION

1. Field of the Invention

The present invention relates to a container, and more particularly to a container having a photo-audio effect to enhance the amusement effect of the container.

2. Description of the Related Art

A conventional container in accordance with the prior art shown in FIG. 6 comprises a column 11 having a first end formed with a support seat 110, an optical sensitive resistor 111 mounted in the support seat 110 of the column 11, a cup 12 mounted on the first end of the column 11 and formed with a recess 120, a mercury device 121 mounted in the recess 120 of the cup 12, a base 10 mounted on a second end of the column 11, a photo-audio circuit 102 mounted in the base 10 and containing a loudspeaker, at least one LED and a circuit board, and a cover 101 mounted on the base 10 to cover the photo-audio circuit 102.

In operation, when the cup 12 is inclined to a determined angle, the mercury contained in the mercury device 121 slips to expose the optical sensitive resistor 111 which contacts the incident light to conduct the photo-audio circuit 102, so that the photo-audio circuit 102 drives the light emitting member to light and drives the loudspeaker to emit sound to provide an amusement effect. Alternatively, when the cup 12 is disposed at a horizontal state, the mercury contained in the mercury device 121 is moved to the original position to encompass the optical sensitive resistor 111 so as to interrupt the photo-audio circuit 102, thereby stopping operation of the photo-audio circuit 102, so that the light emitting member stops lighting and the loudspeaker stops emitting sound.

However, the recess 120 of the cup 12 is designed to have a conic shape to facilitate movement of the mercury. Thus, the mercury cannot slip out of the conical bottom of the recess 120 of the cup 12, so that the optical sensitive resistor 111 cannot contact the incident light to conduct the photo-audio circuit 102, thereby affecting operation of the photo-audio circuit 102.

Another conventional container in accordance with the prior art shown in FIG. 7 was disclosed in the U.S. Pat. No. 5,119,279 and comprises a cup 21, a base 22 mounted on a bottom of the cup 21, a circuit board 223 mounted in the base 22, a battery 224 mounted in the base 22 and connected to the circuit board 223 to supply an electric power to the circuit board 223, at least one LED 221 mounted on the base 22 and connected to the circuit board 223, and a switch 222 mounted on the base 22 and connected to the circuit board 223 to control operation of the LED 221. However, a user has to press the switch 222 so as to control operation of the LED 221, thereby causing inconvenience to the user.

### SUMMARY OF THE INVENTION

In accordance with the present invention, there is provided a container, comprising a photo-audio drive circuit including:
a photo-audio IC (integrated circuit);
at least one light emitting member connected to the photo-audio IC;
a loudspeaker connected to the photo-audio IC; and
two exposed connecting legs each connected to the photo-audio IC.

The primary objective of the present invention is to provide a container having a photo-audio effect to enhance the amusement effect of the container.

Another objective of the present invention is to provide a stirring stick having a photo-audio effect to enhance the amusement effect of the stirring stick.

A further objective of the present invention is to provide a container, wherein the two exposed connecting legs function as a switch of the photo-audio IC to control operation of the photo-audio IC by water (or liquid) contact so as to control operation of the light emitting member and the loudspeaker.

A further objective of the present invention is to provide a container, wherein the photo-audio drive circuit is conducted and driven by liquid contact without having to provide a switch or a mercury device to conduct the circuit, thereby saving costs of fabrication.

A further objective of the present invention is to provide a container, wherein the photo-audio drive circuit is conducted and driven easily and conveniently, thereby facilitating a user operating the photo-audio drive circuit.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of the circuit of a photo-audio drive circuit in accordance with the preferred embodiment of the present invention;

FIG. 2 is an exploded perspective view of a container in accordance with the preferred embodiment of the present invention;

FIG. 3 is a plan cross-sectional assembly view of the container as shown in FIG. 2;

FIG. 4 is a plan view of a stirring stick in accordance with the preferred embodiment of the present invention;

FIG. 5 is a schematic operational view of the stirring stick as shown in FIG. 4 in use;

FIG. 6 is a plan cross-sectional view of a conventional container in accordance with the prior art; and

FIG. 7 is a plan cross-sectional view of another conventional container in accordance with the prior art.

### DETAILED DESCRIPTION OF THE INVENTION

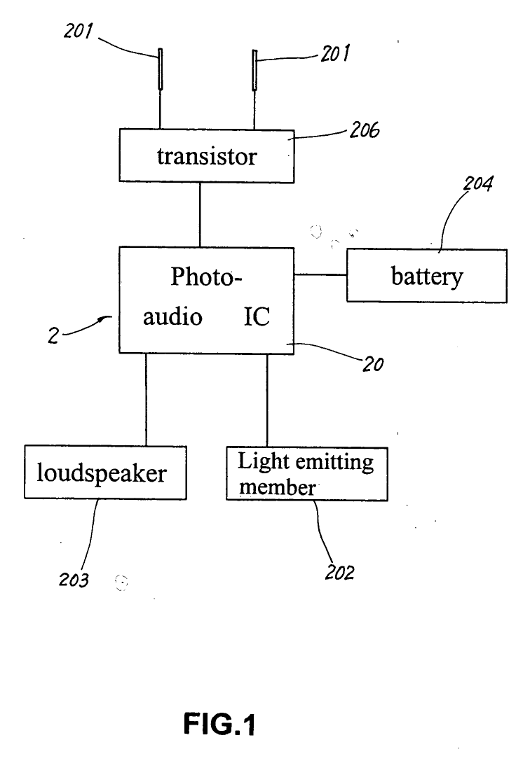

Referring to the drawings and initially to FIG. 1, a photo-audio drive circuit 2 in accordance with the preferred embodiment of the present invention includes a photo-audio IC (integrated circuit) 20, a light emitting member 202 connected to the photo-audio IC 20, a loudspeaker 203 connected to the photo-audio IC 20, a transistor 206 connected to the photo-audio IC 20, a battery 204 connected to the transistor 206 to supply an electric power to the transistor 206, and two exposed connecting legs 201 each connected to the transistor 206, wherein the two exposed connecting legs 201 are electrically connected with each other when contacting water, so that the transistor 206 obtains a positive voltage which is transmitted to the photo-audio IC 20 which drives the light emitting member 202 to light and drives the loudspeaker 203 to emit sound.

Alternatively, the two exposed connecting legs 201 are isolated from with each other when not contacting water, so that the transistor 206 loses the positive voltage to stop operation of the photo-audio IC 20 such that the light emitting member 202 stops lighting and the loudspeaker 203 stops emitting sound.

Thus, the two exposed connecting legs 201 function as a switch of the photo-audio IC 20 to control operation of the photo-audio IC 20 by water contact so as to control operation of the light emitting member 202 and the loudspeaker 203.

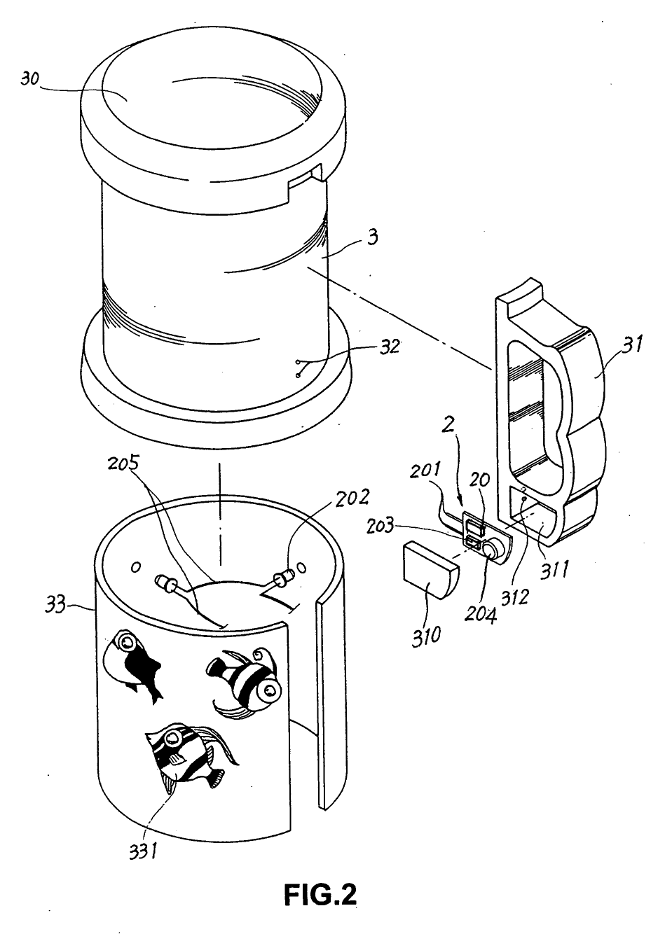

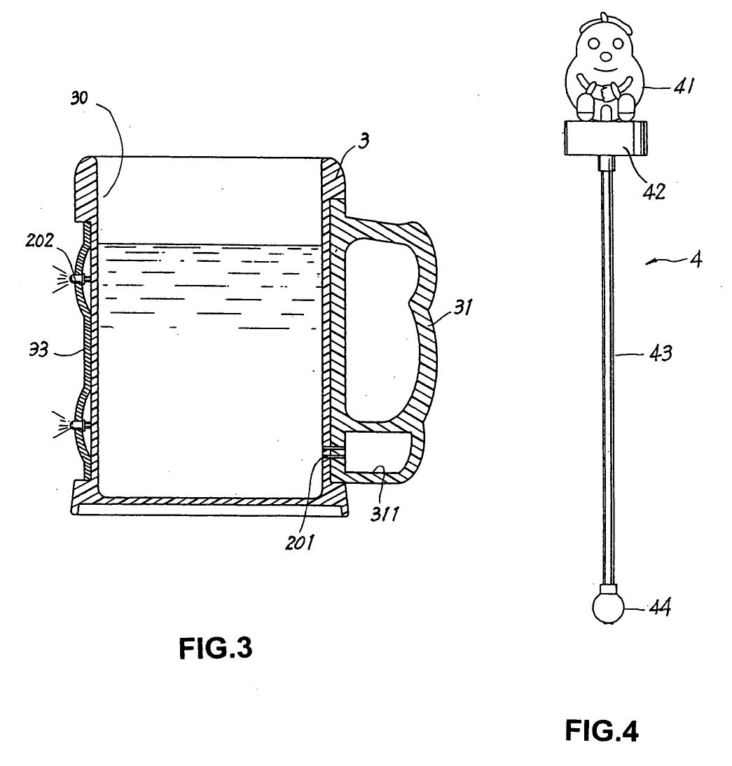

Referring to FIGS. 2 and 3, a container in accordance with the preferred embodiment of the present invention comprises a main body 3 having a peripheral wall formed with two spaced through holes 32 each communicating with an inside 30 of the main body 3, a handle 31 mounted on the main body 3 and having an end formed with a chamber 311 having a side formed with two spaced through holes 312 each communicating with a respective one of the two through holes 32 of the main body 3, a cover 310 mounted in the chamber 311 of the handle 31, and a casing 33 mounted on the peripheral wall of the main body 3 and having a surface provided with a plurality of patterns 331.

The photo-audio drive circuit 2 is mounted in the chamber 311 of the handle 31 and covered by the cover 310. Each of the two connecting legs 201 of the photo-audio drive circuit 2 is extended through a respective one of the two through holes 312 of the handle 31 and a respective one of the two through holes 32 of the main body 3, and extended into and exposed in the inside 30 of the main body 3. The photo-audio drive circuit 2 includes a plurality of light emitting members 202 each mounted on the casing 33 and each aligning with a respective one of the patterns 331. Each of the light emitting members 202 is connected to the photo-audio IC 20 by a conducting wire 205.

In operation, when the water level contained in the inside 30 of the main body 3 exceeds the two connecting legs 201 of the photo-audio drive circuit 2, the two exposed connecting legs 201 are electrically connected with each other when contacting water, to conduct the photo-audio drive circuit 2 to form a circuit, so that the photo-audio IC 20 drives the light emitting members 202 to light and drives the loudspeaker 203 to emit sound. In addition, each of the light emitting members 202 aligns with a respective one of the patterns 331 to enhance the aesthetic quality of the patterns 331.

Alternatively, the two exposed connecting legs 201 are isolated from with each other when not contacting water, so that the photo-audio drive circuit 2 is not conducted to form a circuit, and the photo-audio IC 20 cannot be operated, such that the light emitting members 202 stop lighting and the loudspeaker 203 stops emitting sound.

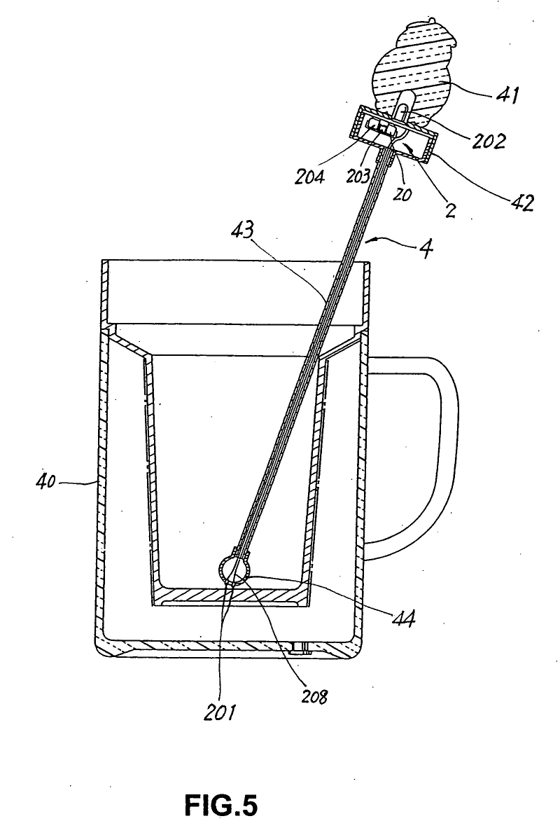

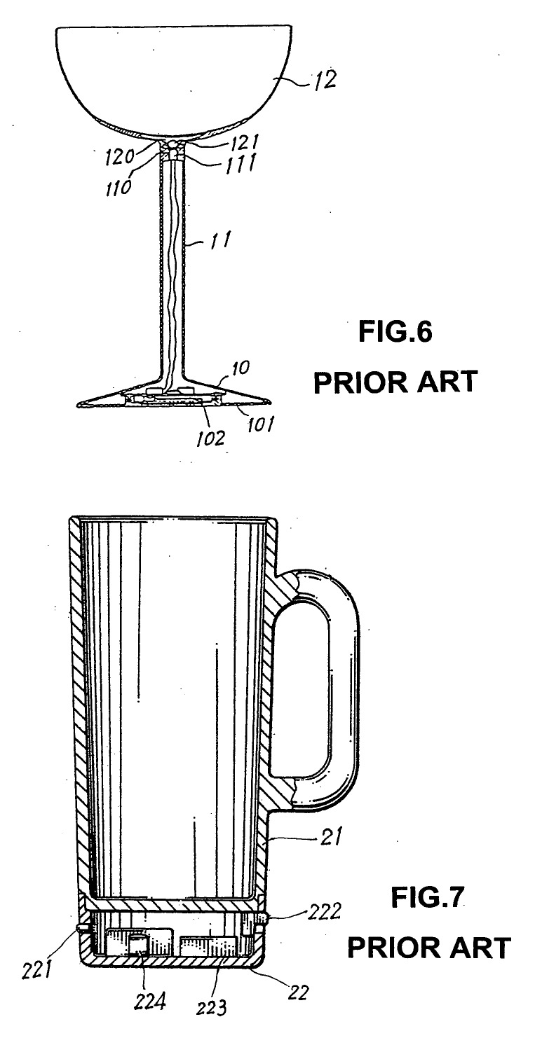

Referring to FIGS. 4 and 5, a stirring stick 4 in accordance with the preferred embodiment of the present invention comprises an elongated bar 43, a handle 41 mounted on a first end of the elongated bar 43 and having an inside formed with a chamber 42 connected to an inside of the elongated bar 43, and a stirring head 44 mounted on a second end of the elongated bar 43.

The photo-audio drive circuit 2 is mounted in the chamber 42 of the handle 41. Each of the two connecting legs 201 of the photo-audio drive circuit 2 is mounted on and protruded outward from the stirring head 44 and is exposed in an inside of a container 40. Each of the two connecting legs 201 of the photo-audio drive circuit 2 is connected to the photo-audio IC 20 by a conducting wire 208.

In operation, when the stirring head 44 of the stirring stick 4 is immersed in the water contained in the container 40, the two exposed connecting legs 201 are electrically connected with each other when contacting water, to conduct the photo-audio drive circuit 2 to form a circuit, so that the photo-audio IC 20 drives the light emitting member 202 to light and drives the loudspeaker 203 to emit sound.

Alternatively, the two exposed connecting legs 201 are isolated from with each other when not contacting water, so that the photo-audio drive circuit 2 is not conducted to form a circuit, and the photo-audio IC 20 cannot be operated, such that the light emitting member 202 stops lighting and the loudspeaker 203 stops emitting sound.

Accordingly, the two exposed connecting legs 201 function as a switch of the photo-audio IC 20 to control operation of the photo-audio IC 20 by water contact so as to control operation of the light emitting member 202 and the loudspeaker 203. In addition, the photo-audio drive circuit 2 is conducted and driven by liquid contact without having to provide a switch or a mercury device to conduct the circuit, thereby saving costs of fabrication. Further, the photo-audio drive circuit 2 is conducted and driven easily and conveniently, thereby facilitating a user operating the photo-audio drive circuit 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A container, comprising a photo-audio drive circuit including:
a photo-audio IC (integrated circuit);
at least one light emitting member connected to the photo-audio IC;
a loudspeaker connected to the photo-audio IC; and
two exposed connecting legs each connected to the photo-audio IC.

2. The container in accordance with claim 1, wherein the two exposed connecting legs are electrically connected with each other when contacting liquid to conduct the photo-audio drive circuit to form a circuit, so that the photo-audio IC drives the light emitting member to light and drives the loudspeaker to emit sound.

3. The container in accordance with claim 1, wherein the two exposed connecting legs are isolated from with each other when not contacting liquid, so that the photo-audio drive circuit is not conducted to form a circuit, and the photo-audio IC cannot be operated, such that the light emitting member stops lighting and the loudspeaker stops emitting sound.

4. The container in accordance with claim 1, further comprising a transistor connected between the photo-audio IC and the two exposed connecting legs.

5. The container in accordance with claim 4, wherein the two exposed connecting legs are electrically connected with each other when contacting liquid, so that the transistor obtains a positive voltage which is transmitted to the photo-audio IC which drives the light emitting member to light and drives the loudspeaker to emit sound.

6. The container in accordance with claim 4, further comprising a battery connected to the transistor to supply an electric power to the transistor.

7. The container in accordance with claim 1, wherein the photo-audio IC has a side connected to the two exposed connecting legs.

8. The container in accordance with claim 1, wherein the two exposed connecting legs are extended outward from the side of the photo-audio IC.
